(19) United States
(12) Patent Application Publication
(10) Pub. No.: US 2001/0029491 A1
(43) Pub. Date: Oct. 11, 2001

(54) Digital information sales method

(75) Inventors: Koichi Yoneta, Yokohama (JP); Masayuki Inoue, Fujisawa (JP); Hidenori Nanami, Ichikawa (JP); Tetsuharu Inamitsu, Chigasaki (JP); Katsutoshi Sato, Chigasaki (JP); Shigeyuki Ito, Zushi (JP); Yutaka Takami, Yokohama (JP); Kenji Matsumoto, Yokohama (JP); Yoshiisa Inoue, Yokohama (JP)

Correspondence Address: McDermottm Will & Emery, 600 13th Street, N.W., Washington, DC, 20005-3096, US

(73) Assignee: HITACHI, LTD.

(21) Appl. No.: 09/773,905

(22) Filed: Feb. 2, 2001

(30) Foreign Application Priority Data
Apr. 11, 2000 (JP) 00-115781

(51) Int. Cl. G06F 17/60; H04K 1/00; H04L 9/00

(52) U.S. Cl. 705/53

(57) ABSTRACT

A method for preventing unauthorized copying of digital information such as digitized movies, music, literature, or other works, and reliably collecting to the digital information owner fees paid for using the copied digital information. When copying key data 156 enabling use of digital information 158, the key data is locked. To unlock the key data, the user accesses digital information seller 150 and pays the digital information usage fee.

### BACKGROUND OF THE INVENTION

The present invention relates to a digital information sales and management system and apparatus.

One of the greatest features of digital information is that there is no data deterioration. This has led to problems relating to the unauthorized duplication and distribution (pirating) of digital information between users, and the unauthorized sale of such duplicated information. Japanese Patent Publication (kokoku) 6-28030, titled a software management system (referred to below as the software management system), teaches one exemplary method for managing such digital information.

### SUMMARY OF THE INVENTION

When providing a method enabling the legitimate use of digital information, some type of security assurance is needed for the digital information that is to be transferred or duplicated from an owner to a user or between users.

The above-noted software management method permits use of the software on the condition that certain information unique to the data for which a fee is charged is stored in specific storage. However, anyone can use the software by simply copying to the specific storage the unique information that is required to use the data. More particularly, if this unique information can be copied from user to user, there is the danger that the software can be distributed similarly to computer freeware, that is, without the user paying the requisite compensation to the owner or authorized seller, and the owner is in danger of not collecting the monies that should be received.

Another aspect of this software management system is that an association uses a rebate incentive to urge users to report specific usage information at an external I/O processor. When the association thus captures the usage information, it transfers to the bank account of the copyright holder a sum corresponding to the content of the information, and fees are thus collected from user to copyright holder. A drawback to this system, however, is that if usage information is reported through a data communications function, all users must have such data communications capability, and this makes it more expensive for the user. It is also necessary to consider usage on terminals that can only operate in an off-line environment when the software is duplicated and distributed between users, and expanding sales to users operating in such an off-line environment cannot be expected with this system.

Therefore, in order to promote the sale and management of digital information such as videos and images, music, and other copyrighted works, an object of the present invention is to provide a method enabling reliable collection and payment to a copyright holder of remuneration fees incurred in conjunction with the use of digital information while also enabling users to use and duplicate digital information with security protections.

Key data required to reproduce (playback) the digital information is encoded to provide the digital information with security protection. This key data is used to determine whether reproducing the digital information is permitted.

The following two methods are used when duplicating the key data to ensure security and fee collection.

In the first method, the transaction fee must be remitted to a marketers' area, which cannot be accessed by the users, when duplicating digital information or key data. With this method a user that has duplicated the digital information can use the digital information, even if it was duplicated off-line, because the key data is usable, unlike in the first method above. In addition, money remitted to the marketers' area can at a later date be collected and paid to the seller on-line or using an ATM machine, assuring that the copyright holder can collect fees even when the data is duplicated off-line.

In the second method the key data is copied in a format that makes the key data unusable when the digital information is duplicated to a user other than the authorized user. The key data becomes unusable when the digital information is copied, and the digital information therefore cannot be used even if the key data is copied. Use through unauthorized copying can therefore be prevented. When the user that has duplicated the digital information wants to use the digital information, however, unusable key data can be unlocked by accessing the marketers' area and paying the fee. Fees can be reliably collected in this case because the marketers' area must be accessed in order to use the digital information.

It should be noted that to accomplish these methods the digital information is sold in conjunction with a program that implements the above-noted copying and collection control methods and is stored with the digital information and key data to the user's storage medium.

### BRIEF DESCRIPTION OF THE DRAWINGS

These and other features, objects and advantages of the present invention will become apparent from the following description when taken in conjunction with the accompanying drawings wherein:

FIG. 1 shows a system configuration 1 according to a preferred embodiment of the present invention;

FIG. 2 is a flow chart showing the steps in a digital information sales routine according to a preferred embodiment of the present invention;

FIG. 3 is a flow chart showing the steps in a digital information playback routine according to a preferred embodiment of the present invention;

FIG. 4 is a flow chart showing the steps in a digital information resale routine according to a preferred embodiment of the present invention;

FIG. 5 shows a first configuration of an IC card according to a preferred embodiment of the present invention;

FIG. 6 shows the flow o f information moving between users in a preferred embodiment of the present invention;

FIG. 7 is a flow chart of a first user-user fee collection routine according to a preferred embodiment of the present invention;

FIG. 8 shows a system configuration 2 according to another preferred embodiment of the present invention;

FIG. 9 shows a second configuration of an IC card according to a preferred embodiment of the present invention;

FIG. 10 is a flow chart of a second user-user fee collection routine according to a preferred embodiment of the present invention;

FIG. 11 is a flow chart of a third user-user fee collection routine according to a preferred embodiment of the present invention;

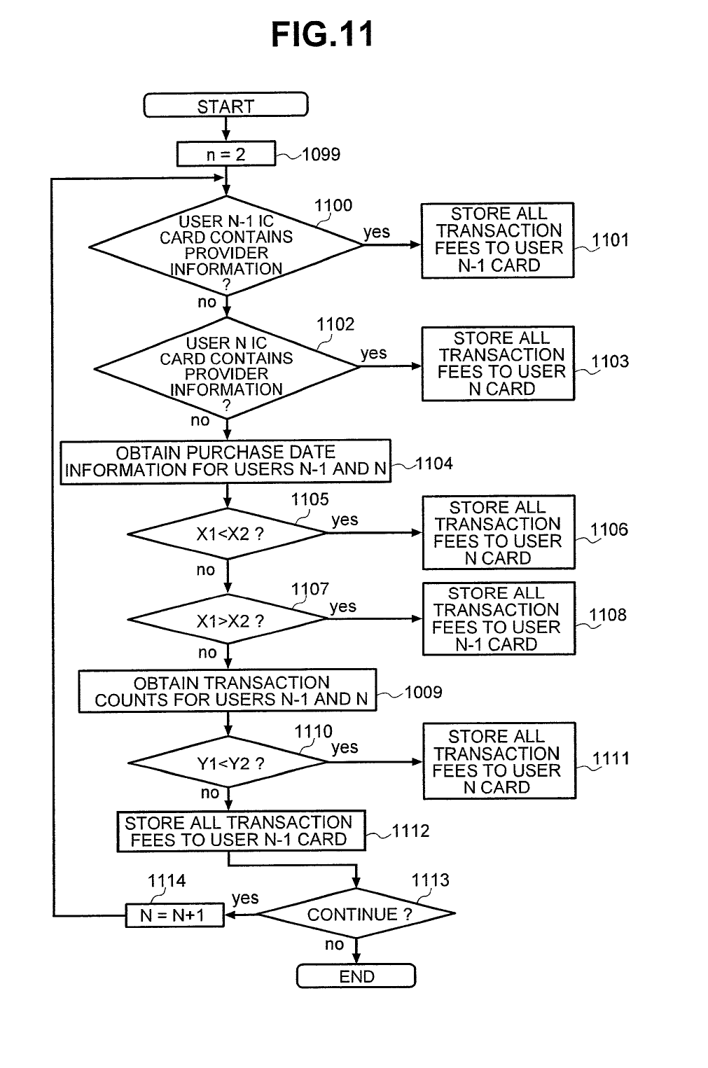

FIG. 12 shows a system configuration according to another preferred embodiment of the present invention;

FIG. 13 is a flow chart of a first bank ATM collection routine according to a preferred embodiment of the present invention;

FIG. 14 is a flow chart of a second bank ATM collection routine according to a preferred embodiment of the present invention;

FIG. 15 shows a system configuration according to another preferred embodiment of the present invention;

FIG. 16 is a flow chart of a fee collection routine according to a preferred embodiment of the present invention; and

FIG. 17 is a f low chart of a fee collection routine according to a preferred embodiment of the present invention.

### DETAILED DESCRIPTION OF THE PREFERRED EMBODIMENTS

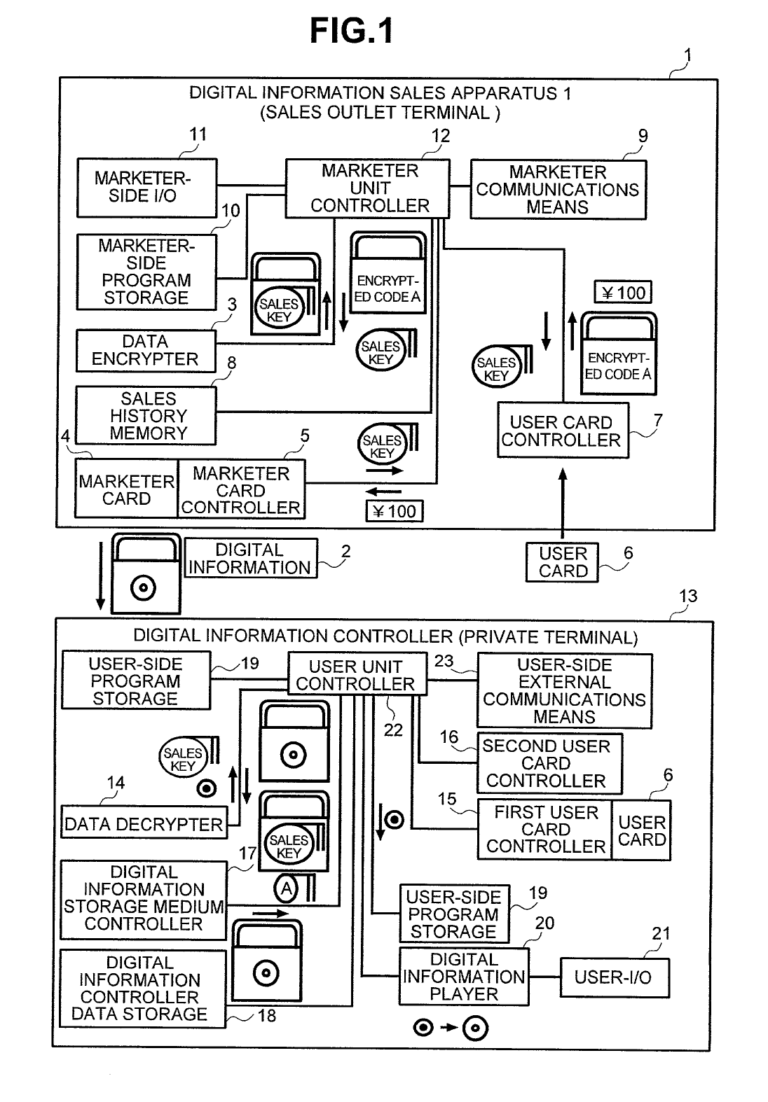

A first preferred embodiment of the present invention is described next below with reference to FIG. 1 to FIG. 4. This first embodiment of the invention requires key data to use digital information, and when copying the digital information and key data requires the deposit of a transaction fee to a marketer area that is inaccessible by the user.

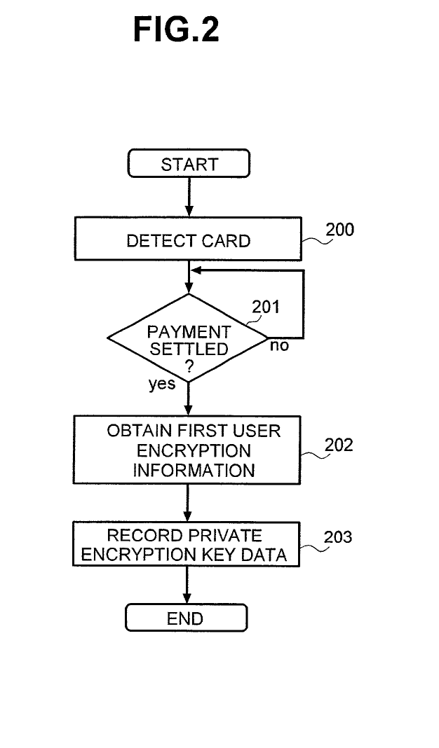

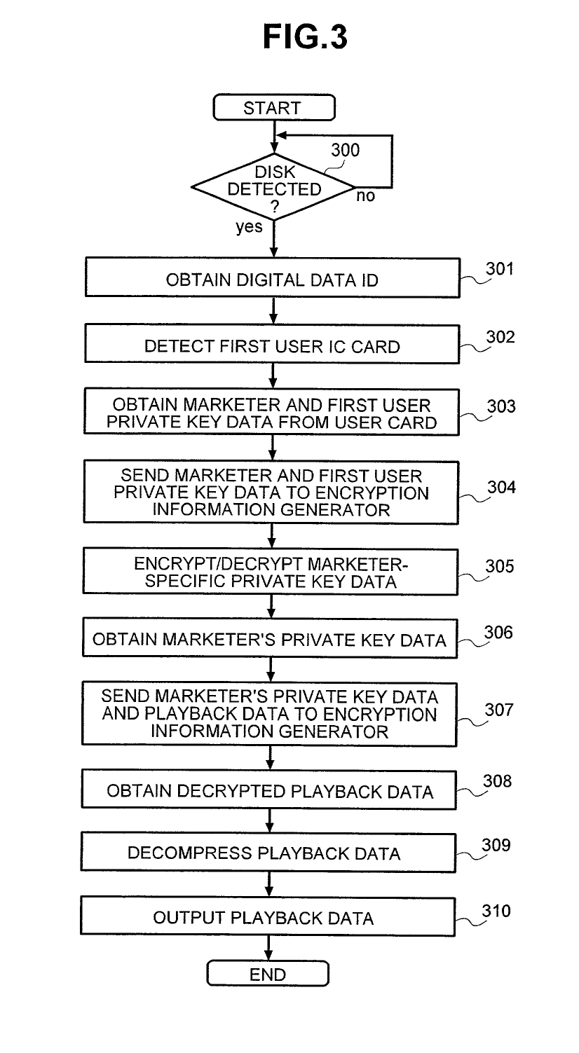

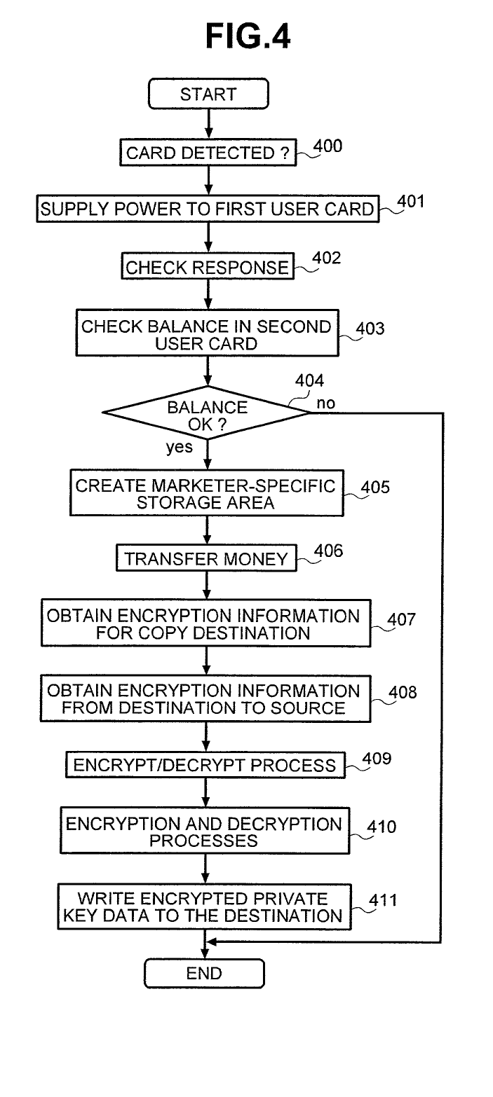

FIG. 1 shows the configuration of a system relating to a method enabling the purchase and resale, as well as the collection of fees therefor, of digital information of value to which the invention is applied. FIG. 2 is a flow chart of a procedure used by this system for the sale of digital information from a copyright holder and a first user purchasing the digital information. FIG. 3 shows a procedure enabling the use of digital information purchased by the first user. FIG. 4 shows a procedure for copying between the first user and a second user that has not directly purchased the digital information from the copyright holder.

Referring to FIG. 1, digital information sales apparatus 1 is a terminal for the marketer or copyright holder selling the digital information. The digital information 2 is video, music, or other copyrighted work that has been encrypted and is unique to the copyright holder or marketer (referred to as simply the marketer below). The data encrypter 3 encrypts the digital information to be marketed with information unique to the marketer using a public key or shared key encryption method. A marketer IC card (“marketer card” below) 4 stores at least marketer-specific information or electronic money information. Marketer card controller 5 reads and writes data to the marketer card 4, and the marketer card 4 is normally loaded into the marketer card controller 5.

A user IC card (“user card” below) 6 stores user-specific information or electronic money information. A user card controller 7 reads and writes the user card 6. The user card 6 is loaded into the user card controller 7 when a user purchases digital information.

Sales history memory 8 stores information about the sales history of the digital information, including the name of the digital information sold and information from the user card. Marketer communications means 9 handles communications between digital information sales apparatus 1 and external devices, and enables direct or indirect connection and communication with the user s terminal. Marketer-side program storage 10 stores the program data required to control the various components of the digital information sales apparatus 1, a program for controlling payments using electronic money information, and other programs as appropriate. Marketer-side input/output means 11 has an output function for outputting the process results from digital information sales apparatus 1 on a display, for example, and an input function for externally entering key data, for example, for processing by the digital information sales apparatus 1. Marketer unit controller 12 controls the components of digital information sales apparatus 1, including data encrypter 3, marketer card controller 5, and user card controller 7. The digital information 2 is stored to a digital data storage medium 23 belonging to the user. Note that the digital information 2 is stored to a storage means (not shown in the figure) in the digital information sales apparatus 1.

Digital information controller 13 is a device enabling the use of digital information purchased by a user by presentation on a display or through speakers, for example. Data decrypter 14 performs a decryption operation required to use the encrypted digital information. First user card controller 15 controls reading and writing information to the user card 6 built in to the first user card controller 15. Second user card controller 16 controls reading and writing user card information. Digital information storage medium controller 17 reads digital information from the storage medium 23 storing the digital information and loaded to the digital information storage medium controller 17. Digital information controller data storage 18 stores information specific to the digital information controller 13.

User-side program storage 19 stores the program data needed to control the various components of the digital information controller 13. Digital information player 20 displays and otherwise outputs the decrypted digital information. User-side input/output means 21 has an output function for outputting the process results from digital information controller 13 on a display, for example, and an input function for externally entering key data, for example, for processing by the digital information controller 13. Marketer unit controller 22 controls the various components of the digital information controller 13, including the data decrypter 14, first user card controller 15, and second user card controller 16. User-side external communications means 23 handles communications between the digital information controller 13 and external devices, and enables communications directly or indirectly with a device belonging to the user.

The marketer-side program storage 10 stores a private key control program for storing a private key to a user-owned storage medium when private key data is sold. This private key data control program controls copying the private key, and collecting usage fees from the marketer area, and also functions on digital information controller 13.

A procedure for handling a sales transaction between a marketer and first user is shown in FIG. 2 and described below. The process run by primarily the digital information sales apparatus 1 when a first user purchases digital information at a digital information sales outlet where the digital information sales apparatus 1 is located is described below. It should be noted that while not shown in FIG. 2 this operation includes storing the digital information 2 the user wants to purchase to a digital data storage medium 23 belonging to the first user. Note further that while the digital information can be stored to the digital data storage medium 23 before paying the fee or storing the private key data (simply “key data” below) further described below, storing the digital information preferably occurs after the fee is paid or the key data is stored.

The process starts when the first user loads his or her user card (“first user card” below) into the user card controller 7 built in to the digital information sales apparatus 1.

When the digital information storage medium marketer unit controller 12 learns from the user card controller 7 that a card has been inserted (200), it collects from this first user card electronic money information equivalent to the fee for the digital information being sold (201). Settling this electronic money transaction involves moving the electronic money from the user card to the marketer's card, and thus subtracts the debited electronic money from the user card balance and adds it to the electronic money balance stored to the marketer card. It should be noted, however, that settling this electronic money transaction involves more than simply reading the data and adding and subtracting values. More specifically, an electronic money control program stored in the marketer-side program storage 10, and a similar electronic money control program stored in the user card and marketer card, are used to handle protocols, encrypting communications data, authentication processes using information specific to the marketer card and user card, and security.

Furthermore, while also not shown in the figures, the area of the first user card to which electronic money is stored is divided into an electronic money storage area usable by the first user, and an electronic money storage area usable only by the marketer. The electronic money storage area restricted to the marketer is reserved for managing electronic money information that is collected as the fee for the digital information when digital information is exchanged between users as further described below.

If collecting the digital information sales fee from the user card to the marketer card is successful (201 returns yes), specific first user information is retrieved from the user card (202). In this case, the first user card information captured from the first user card and information about the purchased digital information (such as the digital information registration name, sale price, sale date, buyer name, and buyer's IC card number) are stored with a correlation therebetween to the sales history memory 8 used for managing the digital information sales history. By collecting and managing such information, it is possible to better respond to customer (buyer) complaints and inquiries, track sales to a particular user, as well as analyze and manage purchasing trends. Data (first user encryption data) that is the basis for encryption that can be decrypted using the private key data of the first user is also gathered at this time. This first user encryption data is different for each user or card, such as the Purse ID (personal ID) or other information.

Based on the captured first user encryption data, the private key data unique to the marketer and required for decrypting the digital information is encrypted. To accomplish this encryption process, the marketer unit controller 12 passes the first user encryption data and marketer-specific private key data to the data encrypter 3. The data encrypter 3 then encrypts the marketer-specific private key data (203). Because the marketer-specific private key data needed to use the digital information is encrypted using information specific to the first user, the marketer-specific private key data cannot be decrypted using a user card not containing the first user encryption data even if the encrypted digital information is copied together with the encrypted marketer-specific private key data to a user card other than this first user card. It is therefore possible to restrict the use of digital information as a result of unauthorized duplication.

A private key data control program for collecting money in the marketer area and controlling duplication of marketer-specific private key data between users is also written to the user card.

Next, the marketer-specific private key data encrypted by the data encrypter 3 is then written to the first user card 6 by user card controller 7, and the sales process for digital information desired by the first user ends. It will be obvious to one with ordinary skill in the related art that feedback can be given to the buyer or marketer during this digital information sales process by, for example, connecting a display to the marketer-side I/O means 11 to present instructions for the buyer, for example, or connecting speakers to the I/O means 11 to provide audible feedback when the buyer uses an illegal IC card, for example, or another error handling process is invoked.

It will be also obvious that while transactions are described as being settled using electronic money above, transactions could also be settled using paper currency and coin, for example.

A procedure enabling the first user to use the digital information purchased by the first user is described next below with reference to FIG. 3.

This process starts when a digital data storage medium 23 storing the digital information 2 purchased from the marketer as described above is loaded into the digital information storage medium controller 17 built in to the user'Is digital information controller 13. When the digital data storage medium 23 is loaded into the digital information storage medium controller 17, the user unit controller 22 detects that the digital information has been loaded (300). Note that the process for detecting whether such digital information is loaded and implementing the steps described below is controlled according to a unit control program stored to the user-side program storage 19.

Next, information specific to the digital information is obtained from the digital information by way of digital information controller 13 (301). This specific information is referred to as the ID number 1700 below. The captured ID number 1700 is encrypted. When loading the digital information and capturing the ID number 1700 are completed, it is detected whether the user card is loaded in first user card controller 15 or second user card controller 16. The above-noted encrypted marketer-specific private key data is stored to the first user card.

It will also be obvious that various methods can be used for determining whether a card is present, including checking the state of a card detection sensor added to first user card controller 15 and second user card controller 16, and checking the ATR (Answer to Reset) information obtained by supplying power, a clock, and reset signal to the user card 6 in conformance with ISO 7816.

When a user card 6 is detected (302), the user unit controller 22 sends a command for reading the private key data by way of the first user card controller in order to obtain the encrypted marketer-specific private key data stored to the user card 6. When the user card 6 receives this command, it responds by returning the marketer-specific private key data. The unique user card information (the first user's private key data in this case) is also sent for decrypting the encrypted marketer-specific private key data (303).

Upon receiving the marketer-specific private key data and first user private key data in response, the user unit controller 22 sends the marketer-specific private key data and first user private key data to the data decrypter 14 (304), and the marketer-specific private key data is decrypted (305). Note that the data decrypter 14 performs an inverse function calculation using the first user private key data used when encrypting the data according to a specified encryption method, and returns the decrypted marketer-specific private key data as output information to the user unit controller 22 (306).

Having received the marketer-specific private key data, user unit controller 22 uses the response from data decrypter 14 to access the digital information loaded into digital information storage medium controller 17 and obtain the data for the part to be played back. Note that the data for the part to be played back is encrypted, must be decrypted before it can be used, and the marketer-specific private key data is required to decrypt the desired information. Therefore, the marketer-specific private key data obtained as noted above, and the data for the part to be played back, are sent to the data decrypter 14 (307), the encrypted data added to the playback data is removed, and the desired playback data is obtained as the response from data decrypter 14 (308).

The appropriate data conversion and data decompression operations are then applied to his playback data by the digital information player 20 (309), and the output therefrom is input to the user-side I/O means 21 to use the video, music, or other information encoded in the digital information (310). It should be noted that this decryption operation is accomplished each time the digital information is played back. In addition, the user-side I/O means 21 is built in to the digital information controller in such a way that external monitoring of internal operations is not possible. For example, if signals exchanged between the digital information player 20 and user-side I/O means 21 are somehow monitored, an integrated monitoring prevention function operates to disable operation of the digital information player 20.

It will be also obvious to one with ordinary skill in the related art that prompts for the user can be presented on the user-side I/O means 21 during this digital information playback process, or an audio output section of the user-side I/O means 21 can be driven to notify the user when an error handling routine is invoked, such as when the user attempts to use an unauthorized IC card.

Each sequence of the digital information playback process is stored to digital information controller data storage 18 as historical information. This historical information can be used for tracking unauthorized processes, and as maintenance information for when operating failures or system errors occur, for example.

Furthermore, on-line communications is enabled by connecting the digital information sales apparatus 1 to an external device by means of user-side external communications means 23. User-side external communications means 23 can also be used to receive on-line help from a marketer-side terminal when a failure or system error occurs, thereby enabling real-time recovery and correction.

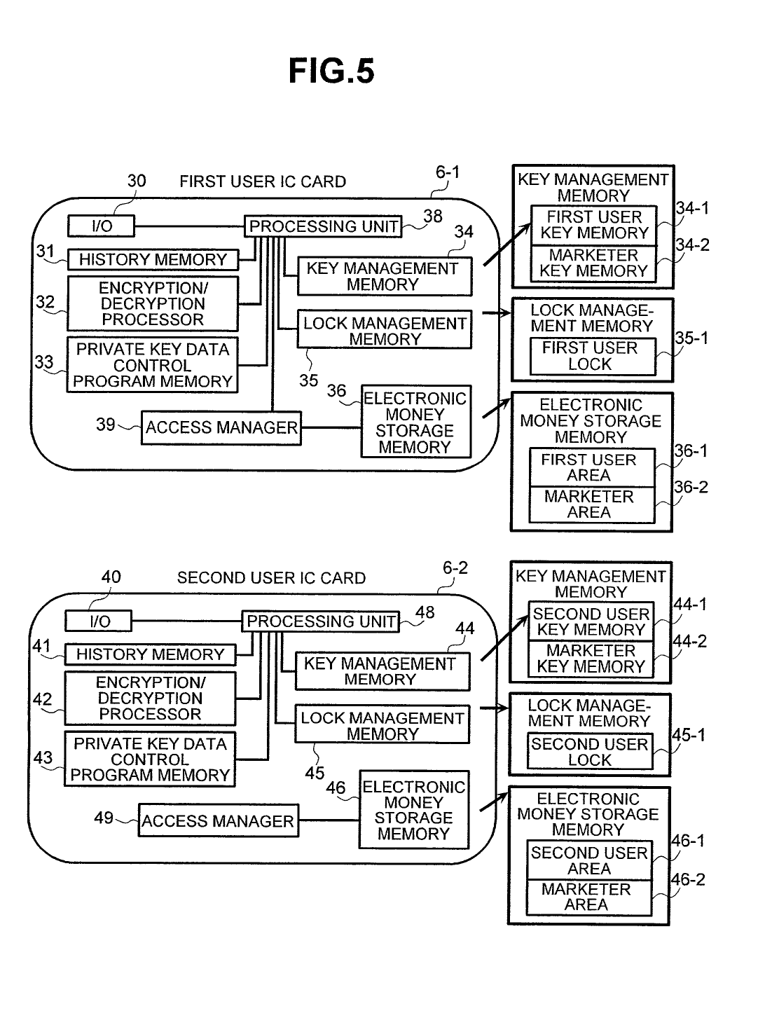

A digital information copying procedure that is a major feature of the present invention for handling the duplication of digital information from a first user to a second user (that is, a user that has not purchased the digital information directly from the marketer) is described next below with reference to FIG. 4. The configuration of the first user card and the second user card (that is, an IC card owned by the second user) is then described in detail with reference to FIG. 5.

In this preferred embodiment of the invention duplicating key data is accomplished by the digital information controller 13 in FIG. 1 according to a private key data program stored to a first storage medium. In addition, the digital information 2 is copied from the digital data storage medium 23 to a digital data storage medium of the second user not shown in the figures. While digital information 2 can be copied at any time, it preferably occurs after selling to the marketer storage area as noted below or after writing the marketer-specific private key data to the IC card of the second user.

The duplication process starts by loading the IC cards of the first and second users into the first user card controller 15 and second user card controller 16. Once both IC cards are loaded into the card controllers (400), the user unit controller supplies a clock signal and reset signal to the I/O sections 30, 40 of the first and second user cards (401).

The purchase history information, which includes the digital information purchase history and the storage history of the marketer-specific private key data for using the digital information, is then returned from the first user card. The purchase history information is obtained from the history memory 31 of the first user card. In conjunction with the purchase history information, price information for purchasing the digital information is also returned from the first user card. This price information is stored in the control program written to the digital information sales apparatus 1 (specifically to the private key data control program memory 33) by the above-described digital information sales process. When the user unit controller receives both the purchase history information and price information (402), control passes to a fee collection sequence.

A command for reading electronic money information from the second user card is sent to the second user by way of second user card controller 16, and receives in response balance information indicating the balance in the IC card (403). If this balance information indicates that the balance in the second user card is sufficient for the price (404 returns yes), a marketer area 46-2 accessible only by the marketer is created in electronic money storage 46 (405), and electronic money information equivalent to the price is stored to marketer area 46-2 (406). As a result, electronic money information equivalent to the price is subtracted from area 46-1, which can be used by the second user, and is added to the electronic money information stored to marketer area 46-2. Note, however, that the process for adding and subtracting this electronic money differs from simply reading the data and performing simple addition and subtraction operations. As noted above, an electronic money control program stored in the second user card (to the electronic money control program memory 47 thereof) is run to handle protocols, communications data encryption, and security procedures such as an authentication process using second user-specific information.

Next, encryption information unique to the second user is obtained from the lock management memory 45 of the second user card (407), and this second user-specific encryption information is sent to the first user card (408). Inside the first user card, the marketer-specific private key data is re-encrypted based on the second user-specific encryption information received from the second user card.

This is accomplished by the first user card processing unit 38 obtaining the encrypted marketer-specific private key data stored to marketer key memory 34-2 in the first user card, and first user private key data stored to first user key memory 34-1, and sending the marketer-specific private key data required for encryption and decryption in conjunction with the second user encryption information obtained from the second user to the encryption/decryption processor 32 (409). The encryption/decryption processor 32 then encrypts the marketer-specific private key data using the second user encryption information. It will be noted that the marketer-specific private key data encrypted with the first user's private key is first decrypted before it is re-encrypted using the second user's encryption information. The result is the creation of an encrypted private marketer key that can be decrypted using the second user's private key (410). By thus accomplishing encryption and decryption of the private key data inside the IC card, security and protection against external monitoring of the encryption/decryption processes, data modification, and other unauthorized access can be improved.

Next, when the user unit controller receives the marketer-specific private key data encrypted using the second user's encryption information, it writes the marketer-specific private key data encrypted using the second user's encryption information to a memory area 44-2 for storing the encrypted marketer key in the second user card (411).

Note that the key data control program for collecting money in the marketer area and controlling duplication of marketer-specific private key data between users is also written to the second user card.

Note that by storing information indicating that marketer key data was written to historical information memory 41 in step 411, this information can be used to manage unauthorized copying. Copy generation control is also possible by writing how many copies (generations) have been made since the digital information was first copied from the marketer and the number of the copy generation. In this case procedures can be added to the program controlling duplication of the marketer-specific private key data so that this generation control information can be used to limit further copying.

It is also preferable to audibly or visually notify the user that “there is a fee for copying this information” whenever the duplication process starts, thereby making it possible to ensure that the duplication process only starts with the user's agreement.

With the completion of this process, a second encrypted marketer's private key is copied from the first user to the second user, and the sale amount is stored to the marketer area inside the second user's IC card.

It will be noted that a duplication process is described above. Completing this duplication process results in the marketer's private key residing in both the first user and second user cards. It is alternatively possible, however, to accomplish a “moving” process whereby the marketer's private key is removed from the corresponding storage area in the first user card and moved to the corresponding storage area in the second user card so that the marketer's private key resides only in the second user card and is no longer present in the first user card. This key data moving process can be accomplished by erasing marketer-specific private key data encrypted using the second user's encryption information from the marketer key storage area 34-1 in the first user card at the point writing the private key data to the second user card is finished.

The above-noted duplication process is thus a process for increasing the number of private keys and is effective for expanding sales using redistribution between individuals. The moving process, on the other hand, does not increase the number of private keys, and is thus effective for distributing digital information in a “limited edition” manner whereby the total number of copies is determined at the time of the original sale.

It will be noted that because a sale history is also recorded with the method according to this preferred embodiment of the invention, it is also possible to manage the absolute number sold directly from the marketer to a user. This effectively enables the marketer to unilaterally control the total number of usable units of digital information supplied to the market.

It will be further noted that the method according to this preferred embodiment of the invention has been described by way of example using a sophisticated security scheme whereby private key data unique to the marketer is encrypted using private key data unique to a first user and private key data unique to a second user. It will also be obvious, however, that the invention shall not be so limited and the invention has benefits without encrypting the marketer-specific private key data using private key data unique to the user.

Furthermore, this preferred embodiment has been described as storing digital information 2 to the digital data storage medium 23 of the user, but the digital information 2 could also be stored with the private key data to the user card 6.

Furthermore, the marketer-specific private key data is described as stored to the user card 6 in the preceding embodiments, but the marketer-specific private key data can be stored with the digital information 2 to the user's digital data storage medium 23.

It will be remembered that this embodiment of the invention has been described as storing a sale price to a marketer area when duplicating the marketer-specific private key data. This control step is defined in the private key data control program. The private key data control program is written by digital information sales apparatus 1 to the user card in conjunction with the sale of digital information. Note, further, that as described above this private key data control program can be stored to the digital data storage medium together with the digital information. The private key data control program itself is, of course, stored to the second user's card or data storage medium when the marketer-specific private key data is duplicated. It is further possible to provide in the digital information controller 13 a control function for storing the sale amount to the marketer area when the marketer-specific private key data is copied, rather than copying the private key data control program when duplicating the digital information.

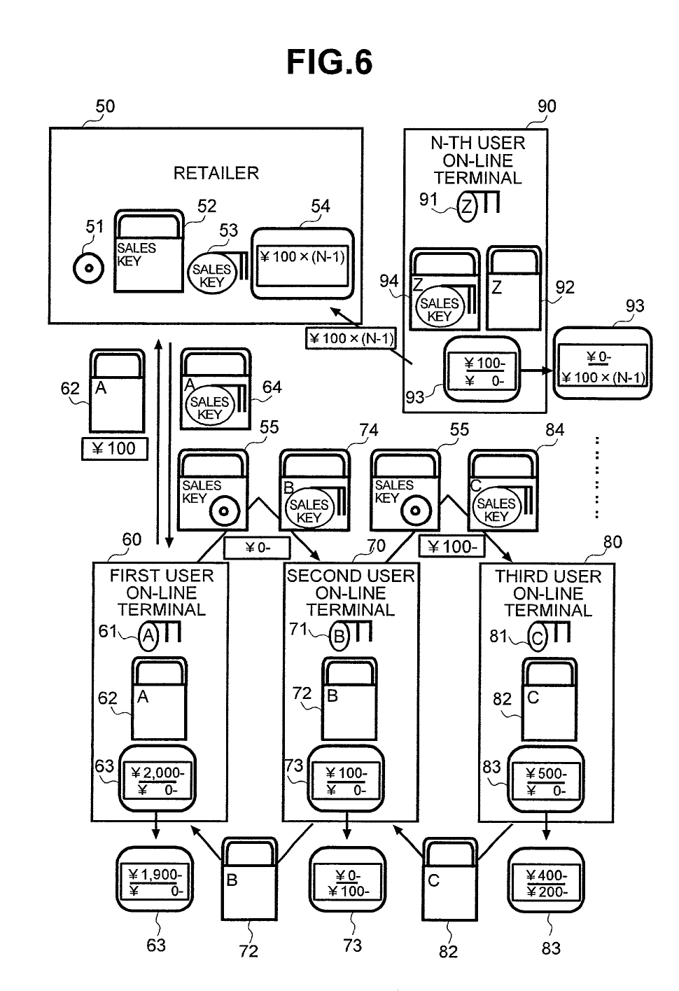

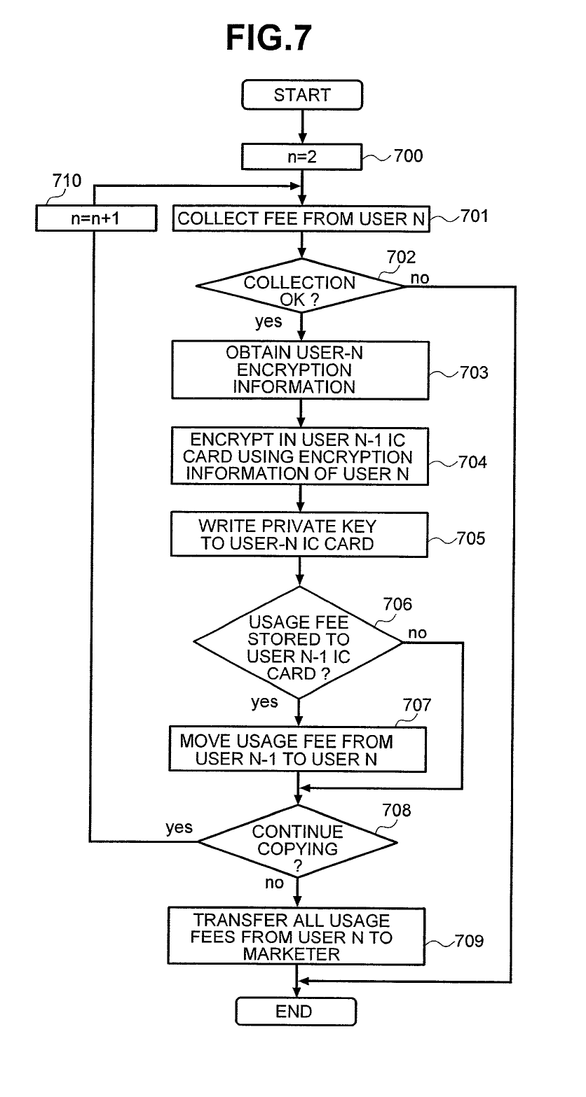

A method for collecting the sale price (electronic money information) stored to the marketer area 46-2 is described next with reference to FIG. 6 and FIG. 7. A method for moving electronic money information equivalent to the cost of purchases for transfers from the first user to a second, third, and n-th user is also described below.

Referring to FIG. 6, retailer 50 is a digital information sales outlet. Digital information 51 is digital information that has not been encrypted. Marketer-specific encryption information 52 encrypts the digital information 51 for sale using the marketer-specific encryption information. Marketer-specific private key data 53 is used when decrypting the digital information. The IC card 54 belonging to the marketer stores the purchase price (electronic money) collected from the user. Digital information 55 is the information encrypted with the marketer-specific encryption information 52. The users are referred to as the first, second, third, to n-th users below.

First user 60 purchases digital information 55 from the marketer. The first user private key data 61 is encryption information for the same user. IC card 63 for the same user stores at least electronic money information. Encrypted key 64 is the marketer-specific private key data encrypted using the encryption information specific to the first user. This information is created when the first user supplies the first-user encryption information to the marketer in order to make a purchase.

It should be noted that the second, third, to n-th users are configured identically to the first user. However, marketer-specific private key data 74 is encrypted within the first user card using the encryption information specific to the second user, marketer-specific private key data 84 is encrypted within the second user card using the encryption information specific to the third user, and marketer-specific private key data 94 is encrypted within user card N−1 using the encryption information specific to the user N.

It is assumed below that the process for handling a sale from the marketer to the first user, and the process for copying from the first user to the second user, are accomplished as described above. The process described below handles copying from a second user to a third user or N-th user, and moving the monies required for the duplication process.

When digital information 55 is copied from the second user to a third user, the third user will need the marketer-specific private key data in order to use the copied information. In this case the digital information 55 is encrypted using the marketer-specific encryption information, and can thus be copied with no problem. In addition, even if the encrypted marketer-specific private key data is duplicated, its encryption means that users other than the user authorized by the marketer cannot use the duplicated information, and thus no problems arise from copying the marketer's private key data.

Copying the marketer-specific private key data 74 to the IC card of the third user means that another purchase of the digital information from the marketer is made, just as it does when the information is copied to the second user card, and another payment of the purchase price is incurred just as when the first user makes a purchase. In the previous example electronic money information equivalent to the sale price is collected from the second user when the private key data 74 is purchased from the first user.

The relationship between the marketer and the electronic money information stored in the card of the third user is described next with reference to FIG. 7.

First, the sale price (assumed to be 100 yen in this example) is first collected from the third user (701). This is accomplished by moving electronic money information of an equivalent amount. More specifically, a marketer area accessible only by the marketer is created in the electronic money information memory of IC card 83 belonging to the third user, and electronic money information equivalent to the sale price is moved to this marketer area. Memory and card configuration in this case are as described above with reference to FIG. 5. If we assume in this fee collection example that 500 yen is stored to third user IC card 83, then the 100 yen sale price is withdrawn from the electronic money information memory of IC card 83 and added to the newly created marketer area.

It should be noted that while simple addition and subtraction operations are performed on the electronic money information to increase and decrease the appropriate electronic money balances in this example, in practice other operations are performed on the encrypted data to maintain a high level of security.

When the sale price is collected (702 returns yes), the third user encryption information 82 is obtained (703). Marketer-specific private key data 84 encrypted with the third user encryption information 82 is then generated using third user encryption information 82, second user private key data 71, and marketer-specific private key data 74 encrypted using second user encryption information 72 (704). The marketer-specific private key data 84 encrypted with the third user's encryption information is then written to the third user's IC card (705). The third user can use the digital information 55 when this writing step is completed. The above-described operation is identical to the process copying digital information to the second user shown in FIG. 4.

When the process copying digital information to a third user card is partially completed, electronic money now belonging to the marketer is stored in the IC cards of both the second and third users. To efficiently collect the monies (electronic money information) accrued to the marketer, a link is made to a copy desired by a subsequent user (a copy of marketer-specific private key data), and electronic money information is moved to the IC card of the subsequent user.

In other words, an electronic money information storage area accessible only to the marketer is present in the second user card, which is the source (original) for the copy made to the third user card. The status of electronic money information in this marketer area is then checked (706). If monies are stored to the IC card of the second user (706 returns yes), the electronic money (equivalent to the sale price) is moved from the second user's IC card to the third user's IC card (707). Moving this electronic money information is accomplished by storing the electronic money information to the marketer area reserved in the third user's IC card with security protections as noted above. As a result, the electronic money information from the second user card is added to the electronic money information in the electronic money information storage area reserved for the marketer in the third user card.

Copying digital information from the third user to a fourth user and between any subsequent users is accomplished using the same process for moving the sale price (electronic money) from the second user to the third user. When the process for copying digital information and the marketer-specific private key data required to use the digital information is completed between user n−1 and the last user n (the last user copying the digital information) (708 returns no), the sale price (electronic money) x stored to the marketer area of the IC card of user n can be calculated using the following equation.

x=digital information sale price x(n−1)

where 2≦n.

If in this example user 8 is the last copy destination, and the digital information sale price is assumed to be 100 yen for all transactions, the electronic money collectible by the marketer when copying to the eighth user is completed will be 700 yen, and the equivalent amount is stored to the IC card of the eighth user.

One method for collecting the sales accumulated by the marketer from the eighth user is to effect an on-line transfer all monies stored in the eighth user's IC card to the marketer's IC card 54 by means of a sales collection program stored to the eighth user card when the eighth user's digital data controller is operating on-line and the eighth user uses the digital information for which sales have been recorded (709). Note that this sales collection program is written to from card to card when copying the marketer-specific private key data as described above so that, for example, the program is written to the eighth user card from the seventh user card when copying the key data to the eighth user card.

Another fee recovery path can be assured when the eighth user's digital data controller is operating in an off-line environment by providing some service to the user in return for the user returning the card for fee collection to the store. For example, a fee collection program could inform the eighth user that a rebate is offered in exchange for returning the card so that fees can be collected. An even higher recovery rate could be expected by offering even greater value, such as the latest information about something, to the user by way of the IC card.

As described above, the private key data is different for each different digital information unit. As a result, when a plurality of digital information sale units are handled using a single IC card, storing the electronic money information to marketer-specific electronic money information storage areas correlated to the private key data makes the fee collection process more convenient.

If there is not enough memory to copy due to limitations of the storage capacity for marketer-specific private key data, it is sufficient to notify the user.

It will be obvious to one with ordinary skill in the related art that while this embodiment is described with the monies in the marketer area being sent when the eighth user is on-line, monies can be transferred when the second user goes on-line.

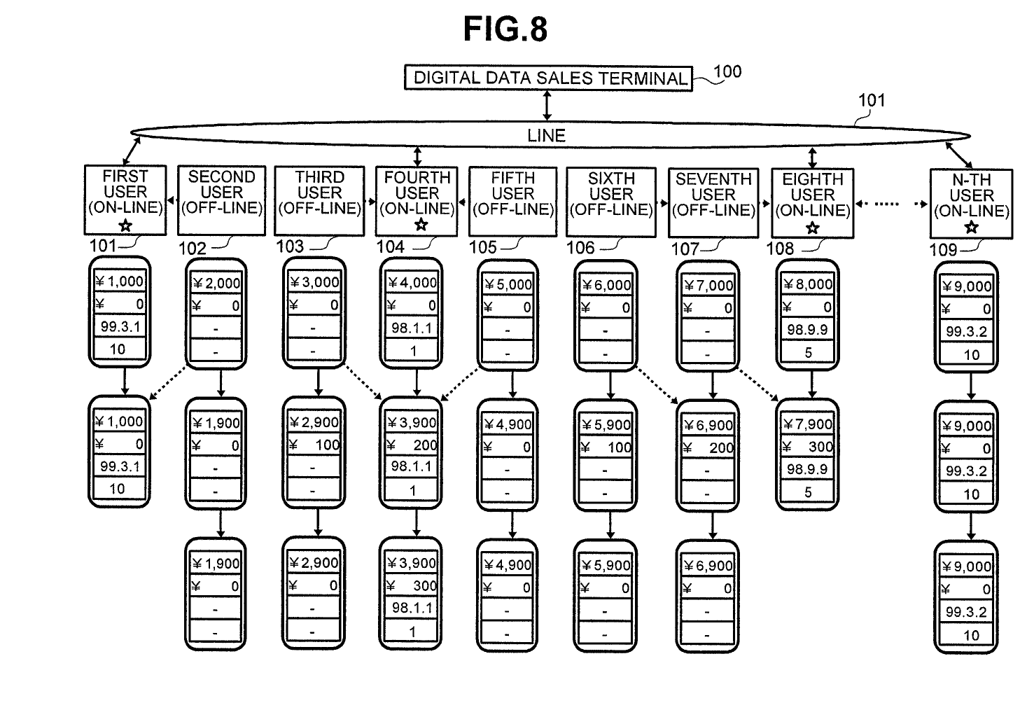

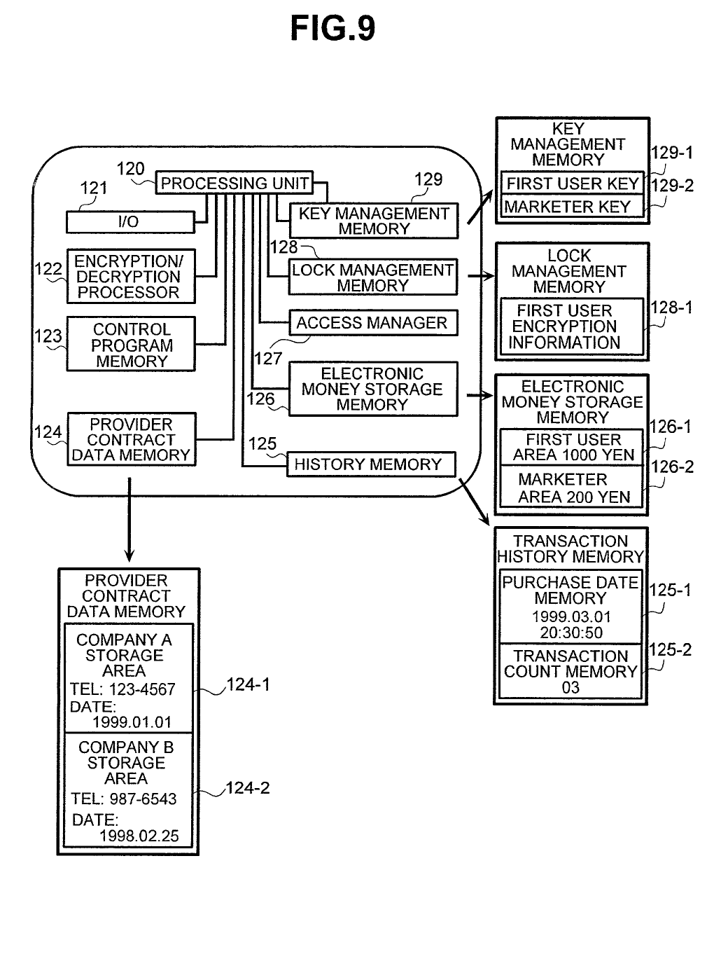

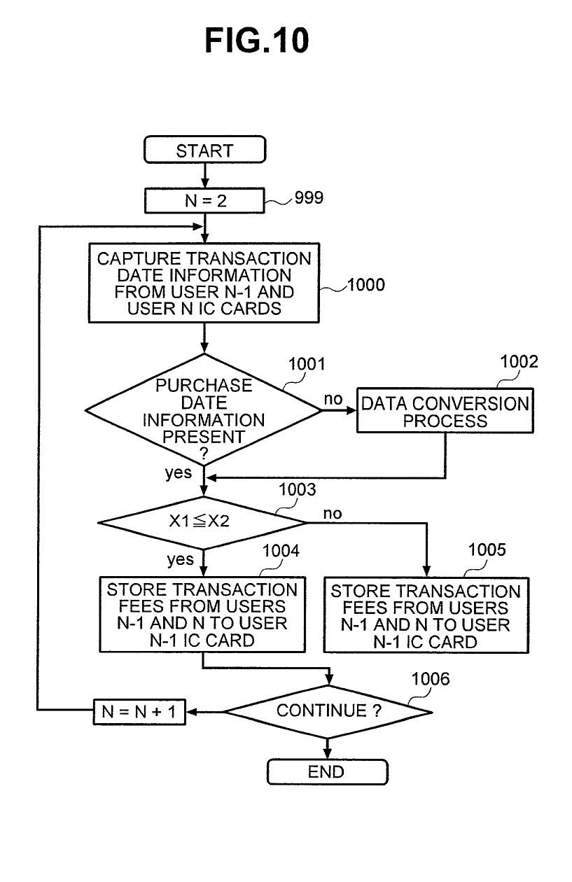

This embodiment has been described as moving electronic money information equivalent to the sale price linked to the marketer-specific private key data. A further method for transferring accumulated monies even more efficiently in an off-line environment is described next with reference to FIG. 8, FIG. 9, and FIG. 10. This method uses information indicating the user's operating environment and past transaction history with the marketer to accomplish this transfer efficiently.

FIG. 8 shows a typical environment including a marketer and digital data control terminals for first to n-th users who have purchased digital information from the marketer. Digital data sales terminal 100 is a digital information sales apparatus 1 having at least a communications function connected to a communications line for communicating with external devices. Digital controllers 101, 104, 108, and 109 belong to individual users; each controller has at least a communications function connected to a communications line for communicating with external devices. Digital controllers 102, 103, 105, 106, and 107 also belong to individual users, but these controllers do not have a communications function connected to a communications line for communicating with external devices. The users and marketers possessing the digital data sales terminal 100 and terminals 101 to 109 also each have an IC card to which electronic money information, transaction history, and other data is stored. Note that this transaction history information is written during direct transactions with the marketer. The line 110 to which each of these terminals is connected could be a telephone line, dedicated line, or other communications path.

As described in the preceding embodiment, marketer-specific private key data is written to the first user card using a method described above to effect a sale of digital information between from the marketer to the first user. In this case, however, information indicating the time of the purchase and the number of transactions with the marketer is also written to a transaction history storage area in the first user card. The content of the transaction history written at this time is described with reference to FIG. 9.

The content of the first user card is described by way of example here. The year, month, date, and time of the transaction is written as the data relating to the purchase date to the purchase date storage area 125-1 reserved for storing digital information purchase date data. This information is used for managing the most recent transaction with the marketer, and is recorded at every transaction between the marketer and user. Note, however, that the previously stored purchase date can be updated (overwritten) with the current purchase date information, or the new purchase date information can be appended. The transaction count, that is, the number of transactions between the marketer and the first user, is also updated (incremented) in the transaction count area 125-2, which is used to track the number of transactions between the marketer and a particular user. The transaction count can be written using the same methods as writing the purchase date information.

When the first user terminal is operating in an on-line environment to make a transaction with the marketer, sending the digital information, settling the sale (using electronic money information), and writing the marketer-specific private key data can be accomplished in real-time on-line. The user could also visit the marketer (sales outlet, for example) to make the transaction, including writing the above-noted information.

As previously described, the sale price can be easily and reliably collected by the marketer from the first user. The problem, therefore, is how to efficiently and effectively collect transaction fees for copying the digital information from the first user to the n-th user. A method for controlling the transfer of transaction fees to an n-th user using the transaction history information stored to the IC card is described next based on the method for transferring transaction fees from the first user to the second user in the copying process described above.

The duplication process for copying marketer-specific private key data between the first and second users is run under the operating environment of the first or second user. That is, electronic money information equivalent to the transaction fee is moved from the second user's electronic money storage area in the second user's IC card and stored to the marketer area in the second user's IC card; then, the marketer-specific private key data encrypted using the first-user encryption information is decrypted and then encrypted to marketer-specific private key data encrypted using the encryption information specific to the second user. This information is also written to the second user card. After these operations are completed, transaction history information is obtained from the first and second user cards (step 1000 in FIG. 10).

The information that can be captured in this step is the purchase date information stored to purchase date storage area 125-1, and the transaction count information stored to transaction count area 125-2. This data for the first and second users is compared and the electronic money information is transferred. Note that only the purchase date information is compared in this step, and the transaction fee is transferred from the IC card having the older purchase date information to the IC card having the newer purchase date information.

If the purchase date information captured in step 1000 is expressed using the Gregorian calendar, seven bytes are used to define the date, and the first user purchase was at 13 hours 00 minutes 00 seconds on 1999 (year) 03 (month) 01 (day) (1001 returns yes), the purchase date can be expressed using hexadecimal notation as

136303010D0000h (hexadecimal)

where 2 bytes are used for the year, 1 byte for the month, 1 byte for the day, 1 byte for the hour, 1 byte for the minute, and 1 byte for the second.

If there have no direct transactions with the marketer (1001 returns no), there is no purchase date information on the IC card, and a value of

FFFFFFFFFFFFFFh (hexadecimal)

is substituted as the purchase date (1002).

Based on this condition, if X1 is the purchase date information from the IC card of user n−1, X2 is the date from the IC card of user n, and X1≦X2, all transaction fees stored to both user's IC cards are stored to the IC card of user n−1.

In the example shown in FIG. 8, purchase date information (Mar. 1, 1999) is stored to the first user card, but there is no purchase date information stored to the second user card. In this case the transaction fee is stored to the IC card of the first user.

This method is followed when thereafter copying between users 2 to n (1006 returns yes). When copying between the last user n and user n−1 is completed (1006 returns no), the transaction fees will be stored to the IC card to which the transaction history information is stored.

The transaction count information can be used in place of the purchase date information. In this case precedence is assigned in transaction count order so that data is moved to the IC card with the highest transaction count. In this case, however, the transaction count information when there have no direct transactions with the marketer is set to 00h. If the first user transaction count is Y1 and the second user transaction count is Y2, all transaction fees stored to both IC cards are moved to the first user IC card when Y1H≧Y2.

Collection of transaction fees to the marketer can thus be further improved by transferring transaction fee information to the IC card that has been used for direct transactions with the marketer and has either been used most recently or most frequently.

A method for yet further improving transaction fee collections controls transferring transaction fees based on information stored to a provider contract data memory as shown in FIG. 9. This method uses the features of an on-line terminal that is also used to make one of a number of copies starting from the first user, and more specifically uses this on-line terminal to send (collect) in one batch the transaction fees accumulated between users having terminals used off-line. This method can be used in conjunction with the purchase date information and transaction count information as described above, or limited to using the data stored to provider contract data memory 124.

An embodiment using this method in conjunction with the purchase date information and transaction count information is described below. It should be noted, therefore, that this method assumes various provider information is pre-stored to the provider contract data memory 124. This provider information is information about the Internet or other network connection used for communication by the user, and more specifically includes such information as the name of the company providing the server enabling network access, the telephone number of a contact, or an identifying server number.

Note, further, that the process described below is accomplished after moving electronic money information equivalent to the transaction fee to the marketer area from the electronic money information stored to the n-user area of the n-user IC card; decryption and encryption operations to convert the marketer-specific private key data encrypted with the encryption information specific to user n−1 to marketer-specific private key data encrypted with encryption information specific to user n; and then writing this information to the IC card of user n.

Information from the provider contract data memory of user n−1 is read to detect whether the provider information is available. If it is (1100 returns yes), all transaction fees stored to both user IC cards are stored to the IC card of user n−1 (1101). If no provider information is stored to the IC card of user n−1 (1100 returns no), the data in the provider contract data memory of user n is read to detect whether the provider information is available. If it is (1102 returns yes), the all transaction fees stored to both user IC cards are stored to the IC card of user n (1103). If no provider information is stored to the IC card of user n (1102 returns no), the purchase date information is read from both IC cards (1104) and compared.

If in this example X1 is the purchase date information from the IC card of user n−1, X2 is the date from the IC card of user n, and X1<X2 (1105 returns yes), all transaction fees stored to both user's IC cards are stored to the IC card of user n (1106). Note that X is greater in this case if the date is more recent. If X1>X2 (1107 returns yes), the fees are stored to the user n−1 card (1108). If X1=X2, the transaction count information is read from both cards (1109) and compared.

If Y1 is the transaction count for user n−1 and Y2 is the transaction count for user n, and Y1<Y2 (1110), fees are stored to the user n IC card (1111); the fees are otherwise stored to the user n−1 card (1112). If this procedure is to continue (1113), n is incremented one and the procedure loops back to step 1100. Note that if no purchase date information or transaction count information is recorded, the null values described above are substituted in the above comparisons.

The precedence controlling the transfer of stored transaction fees above is first to the IC card to which provider information is stored, second to the IC card having a transaction with the marketer closest to the date when the copy was made, and third to the IC card having a high transaction count and therefore a high probability of another transaction with the marketer.

To collect transaction fees stored to an IC card, particularly to an IC card containing provider information, the telephone number stored as the contact number for the marketer is automatically dialed when the user accesses the Internet or other network. After establishing a communications connection, electronic money information equivalent to the transaction fee total is transferred from the user's IC card and stored to the electronic money information memory of the marketer's IC card, and collection is completed. The telephone number used in this case is preferably a toll-free call for the user so as to not impose an additional communications charge on the user. This method thus enables a marketer that tends to become lost in the off-line environment to efficiently collect electronic money information with a high probability of success.

A method for collecting digital information transaction fees using an application not directly contributing to the purchase of digital information is described next below. This method assumes that plural applications are stored to the user's IC card or other storage medium.

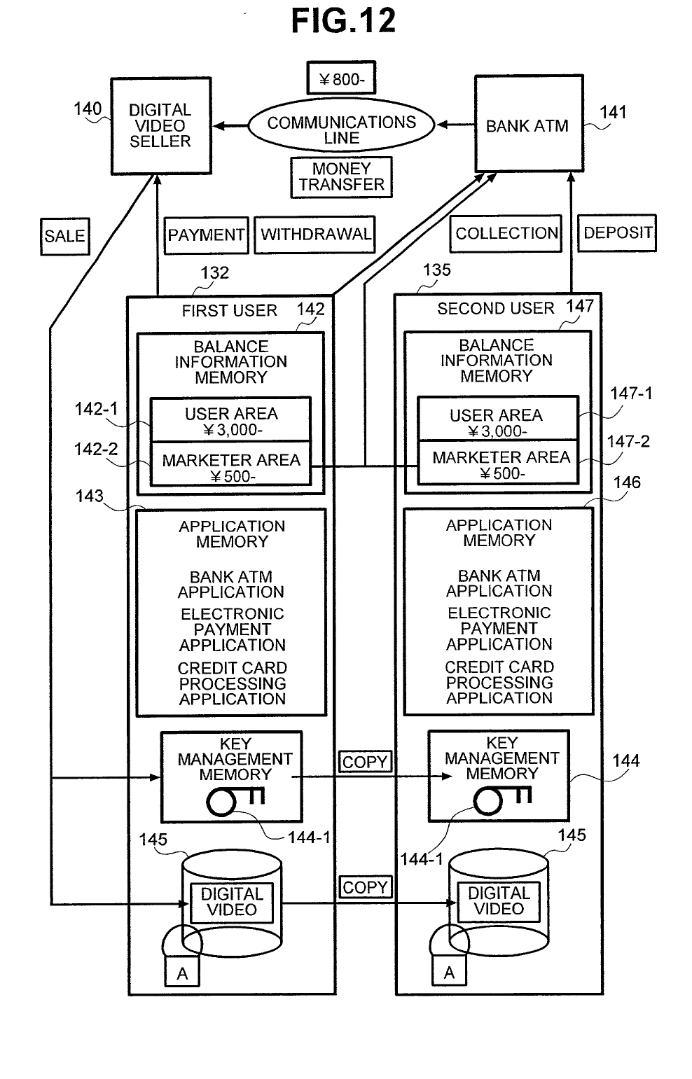

FIG. 12 shows the configuration of a system according to this preferred embodiment of the invention. Digital video seller 140 markets digital video materials and other types of digital information. Bank ATM 141 enables bank withdrawals, deposits, transfers, and other banking transactions. Balance information memory 142 stores the user's money balance. User area 142-1 stores the electronic money data usable by user 1. Marketer area 142-2 is the area in the IC card of user 1 for the marketer to collect transaction fees. Application memory 143 resides in the first user IC card 132, and stores applications such as for settling transactions using electronic money, and a point management application. Key management memory 144 stores the key data 144-1 required to play back the digital video. The second user card 135 is configured identically to the first user IC card 132.

When the first user concludes payment for digital information purchased from digital video seller 140, digital video 145 and key data 144-1 for reproducing the digital video 145 are written to the key management memory 144 of the first user IC card 132. Note that the digital video in this case can be stored to a storage medium other than the IC card, and thus not stored to the IC card. In this embodiment, however, we assume the digital video is stored to the IC card.

User 1 can thus reproduce and view digital video 145 using the digital video 145 stored to the user's IC card and the key data 144-1 stored to the key management area.

In the procedure for copying the key data 144-1 from user 1 to user 2, electronic money information equivalent to the digital video purchase price (transaction fee, 300 yen in this example) is first transferred to the marketer area 147-2 from the user area 147-1 in the second user card 135, and copying the key data 144-1 is then allowed.

This is accomplished by the electronic payment application stored to the application memory 146 of the second user card, and this electronic money application is copied from the first user card to the second user card when copying the key data 144-1 begins. This application is likewise copied from the marketer to application memory 143 of user 1 when user 1 settles a purchase with the marketer. By storing electronic money to the marketer area as the transaction fee, copying the key data to the key management area is permitted and user 2 is able to reproduce the digital video 145. Note that a feature of this operation is that electronic money information is always stored to the marketer area 147-2 as part of the key data copying process.

When the balance in user area 147-1 is insufficient to settle the transaction, copying the key data is prohibited and reproducing digital video 145 is not possible. Furthermore, the electronic money information stored to marketer area 147-2 is normally locked using marketer-specific information, and cannot be used by the second user. Inputting the marketer-specific information is required to unlock the electronic money information. The electronic payment application controls storing electronic money information and the locked/unlocked state of the electronic money information. These operations are as previously described above.

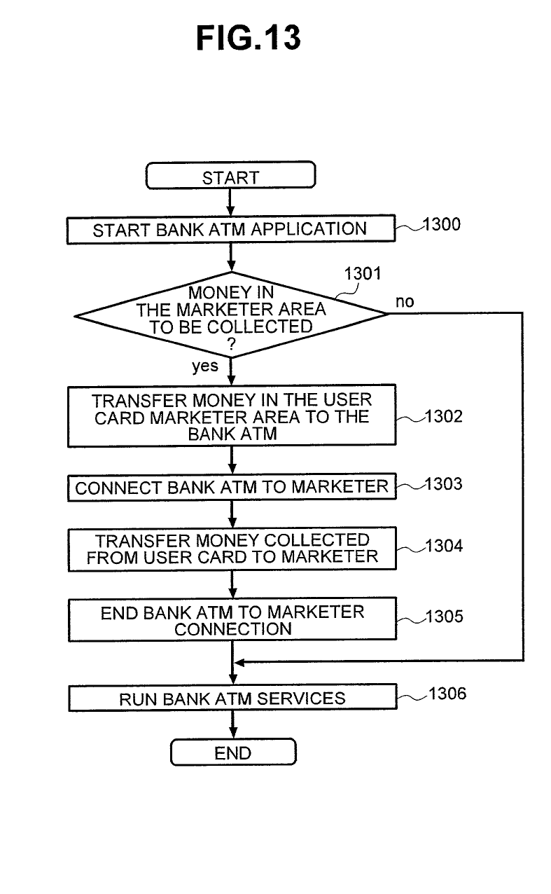

Collecting electronic money information stored as the transaction fees to the user 2 marketer area 147-2 is described next below with reference to the flow chart in FIG. 13.

Let us assume here that the bank ATM application is stored to the application memory of user card 2, and user 2 uses the second user card 135 to make deposits, withdrawals, and transfers. When user 2 makes a transfer using the bank ATM 141, the bank ATM application stored to the application memory starts (1300). Note that an application manager (not shown in the figure) first confirms that the transaction fee is stored to the electronic payment application, and then starts the bank ATM application.

If it is confirmed that the transaction fee is stored to marketer area 147-2 (1301 returns yes), the electronic payment application sends the total transaction fee to the bank ATM 141 (1302). When the bank ATM 141 receives the transaction fee, it receives from the second user's IC card 135 information identifying the address (contact information) of the marketer to which the transaction fee is to be sent (collected by). The electronic payment application also controls sending the marketer contact information. When the bank ATM receives the transaction fee and contact information, it immediately connects to the marketer (1303), and transfers to digital video seller 140 all transaction fees collected from user 2 (1304). When fee transmittal is completed, the connection between the digital video seller 140 and bank ATM 141 is ended (1305) and the bank ATM services are provided. Control switches at this point from the electronic payment application to the bank ATM application in the IC card of user 2, and fund transfers can then be made. When user 2 completes the transfer process, payment of fees to the digital video seller 140 will be completed.

When a single IC card enables using a plurality of applications for purposes, such as shopping and bank transfers, other than just reproducing digital information, this variation of the present invention expands transaction fee collection routes from the user to the marketer using intentional actions of the user by transferring fees accumulated in the IC card to the marketer in a background process.

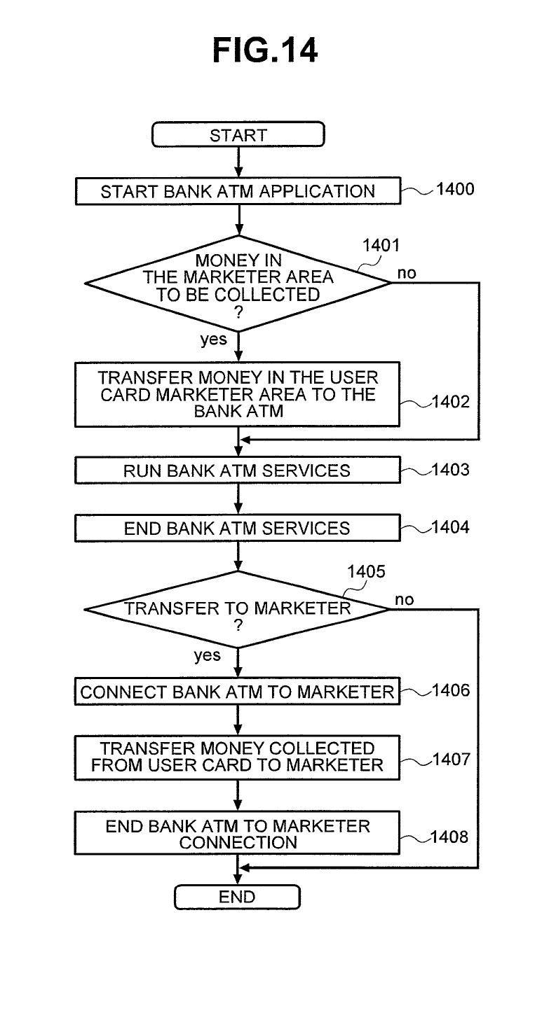

It should be noted that the transaction fees are transferred to the digital information marketer by way of the bank ATM before executing the fund transfer process intended by the user. It will be obvious to one with ordinary skill in the related art, however, that this transaction fee information and transfer data can be stored temporarily in the bank ATM and the actual transfer to the marketer completed after completing the transfer process between the user card and ATM intended by the user. A method for accomplishing this is described next below with reference to the flow chart in FIG. 14.

When user 2 uses the ATM with a transaction fee for digital video 145 stored to marketer area 147-2, user 2 loads the second user card 135 into bank ATM 141 for a fund transfer process. The relationship between starting the application manager, bank ATM application, and electronic payment application is the same as described above. The bank ATM application starts first (1400), but the electronic payment application then confirms the status of marketer area 147-2 (1401). If a transaction fee is stored (1401 returns yes), all transaction fees and them contact information are transferred to the bank ATM 141, and the electronic payment application terminates (1402). The transfer process between the ATM and user 2 ATM application then starts (1403). If the transfer is completed successfully, ATM service ends (1404) and the user 2 IC card is ejected.

As noted above, the transaction fee and related information has already been transferred to the ATM before the card is ejected, and the IC card therefore need not be loaded in the ATM to complete the transfer to the marketer. Therefore, the ATM confirms whether a transaction fee has been received for transfer to a marketer. If there is (1405 returns yes), a communications line connection to the marketer is made (1406). If a successful connection is made, the electronic money transfer commences (1407). If the transfer is successfully completed, the connection between the digital video seller 140 and bank ATM 141 is broken and collection of transaction fees to the marketer ends (1408). Note that transaction fee transfers to the marketer are made more reliable by reconnecting if there is a connection failure, or repeating the fee transfer process if an error occurs while transferring the transaction fees to be remitted to the marketer.

The above example has been described transferring transaction fees from user 2 to the marketer by way of a bank ATM, but the application manager could also be written to collect transaction fees by means of a credit processing application when the IC card is used for shopping purchases. In this case the credit card transaction processor could transfer electronic money information equivalent to the transaction fees due, or could transfer actual monies to the bank account of the marketer. In this example the bank ATM application and electronic payment application preferably run in parallel so that transfers to the marketer by the electronic payment application are accomplished in the background while the user proceeds with the user's transfer process in the foreground.

It is thus possible to collect fees due using an application separate and different from the digital video playback application. The collection route from user to marketer is thus further expanded, and a more reliable fee collection route can be achieved without the user being aware of the process for remitting fees to the marketer.

Control of private key data duplication, control of transferring transaction fees to a secure marketer area in conjunction with private key data duplication, and control of transferring transaction fees from the marketer area to a payment center, are defined in the private key data control program distributed and provided by the marketer, for example. This private key data control program is stored to the user's IC card or other data storage medium in conjunction with private key data duplication.

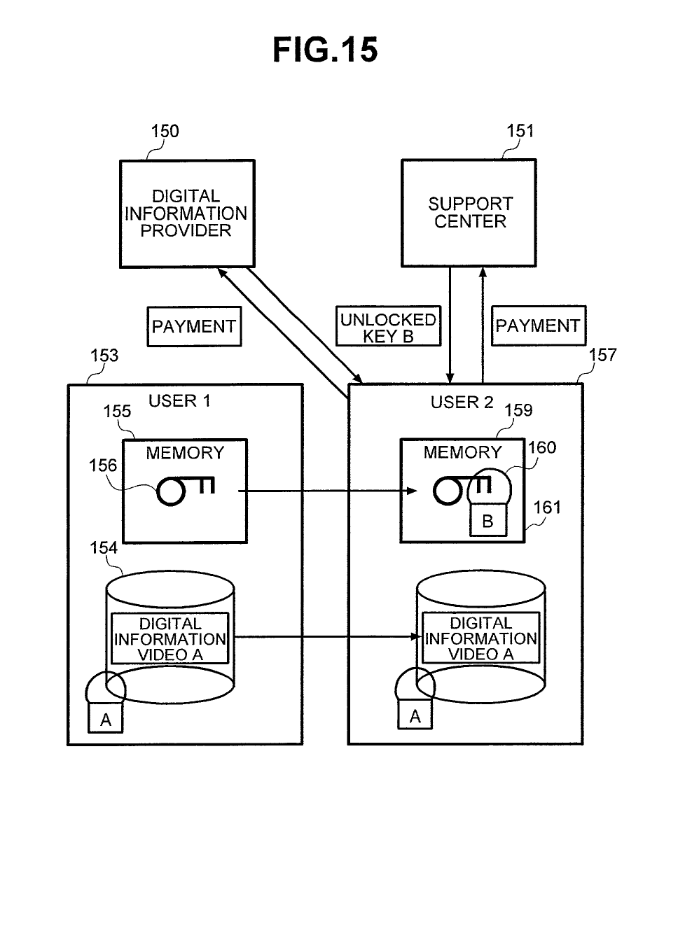

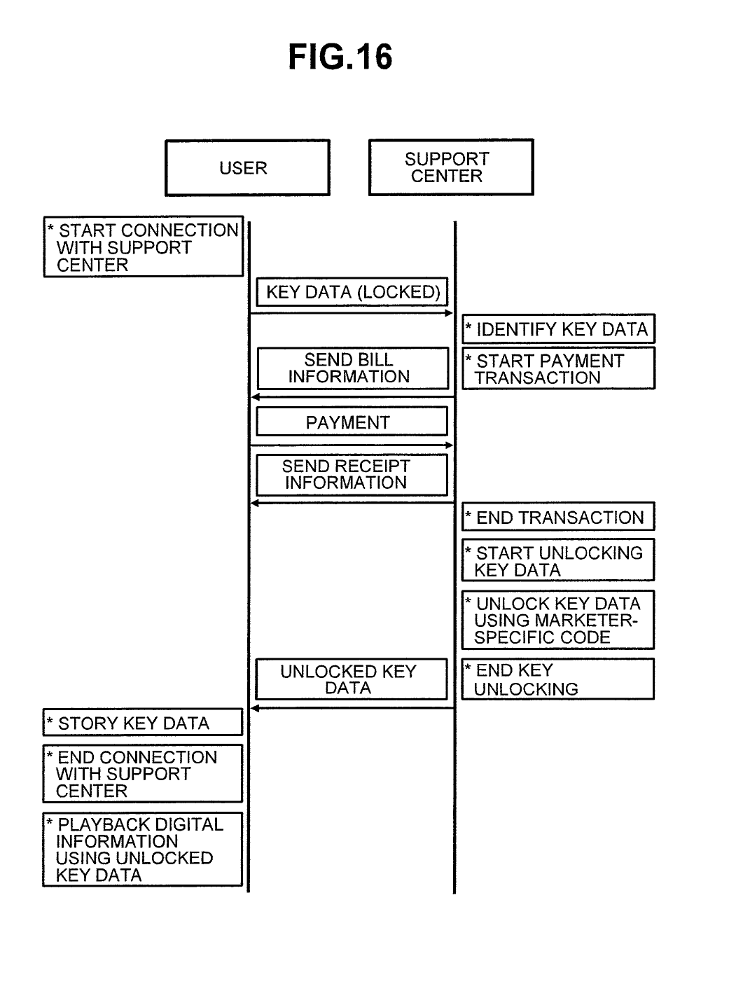

A second embodiment of the present invention is described next with reference to FIG. 15 and FIG. 16. When duplicating the digital information and key data in this embodiment, the key data is copied so that it is unusable. The user must then access a payment center to unlock the key data.

FIG. 15 shows the configuration of this system. Digital information seller 150 is a distribution center for selling digital information. A digital information sales apparatus having a data storage medium containing the digital information, key data, and marketing program including a key data control program is installed at the digital information seller 150. Support center 151 provides user support, including assistance with using the digital information and offering the latest information.

Storage medium 153 belongs to the first user, and may be, for example, a hard disk, magneto-optical disk, magnetic disk, IC card, memory card, SIM card, or other type of medium. This storage medium 153 also stores the digital information 154 purchased from the seller. To prevent unauthorized use, digital information 154 is encrypted. Memory 155 stores the data required for the first user to use the purchased digital information, including the key data 156 for using digital information 154. This key data 156 is, for example, the private key needed to decrypt the encrypted digital information 154.

Storage medium 157 belongs to the second user. This storage medium 157 stores the digital information 158 copied from the storage medium 153 of the first user. Memory 159 stores the data needed for the second user to use the digital information. Key data 160 is locked by lock data 161, that is, it is rendered unusable.

In this configuration digital information 154 is made usable by means of key data 156. When the first user pays the fee for the digital information 154 and key data 156, the first user has the digital information 154, key data 156, and key data control program written to the first user storage medium 153 from the digital information seller 150. When the first user plays the digital information 154 back, the encrypted digital information is decrypted using key data 156 so that the digital information can then be reproduced. This decryption step occurs each time the digital information is reproduced. This operation is identical to that described in the first embodiment above, and digital information sales apparatus 1 and digital information controller 13 described with reference to FIG. 1 are therefore used.

A method for copying digital information to a second user from a first user that purchased the digital information from the digital information sales apparatus 1 is described next.

Digital information controller 13 described in the first embodiment above is used for copying the digital information and key data from first user storage medium 153 to second user storage medium 157. What differs in this operation from the first embodiment is the method of copying the key data.

More specifically, in the first embodiment the key data is copied in a form enabling the second user to use the key data. In the present embodiment, however, key data copied to the second user is copied with the key data locked so that it cannot be used. It will be remembered that the digital information 134 can be copied freely and without restriction because it cannot be used unless the key data 137 is also present on the user's data storage medium. Furthermore, when the key data 156 is written to the first user IC card 153, the data indicating the locked/unlocked state of the key data is set to “unlocked.” The first user can therefore play back the digital information 154 because the key data is unlocked.

A procedure for copying from the first user to the second user is described below. First, a command is issued to copy digital information from the first user to the second user. When this command is detected, the first user card controller 15 and second user card controller 16 copy the key data together with the digital information 154. Note that the key data control program written from the marketer to the first user storage medium controls copying the key data.

When copying key data 156 from the first user to the second user, the unlocked key data 156 resident on the first user IC card is first locked and then written to the copy destination, that is, the second user's storage medium 157.

Locking the key data is described briefly next.

The key data comprises a 1-byte header, 1-byte declaring the data size, a maximum 254-byte data block containing a maximum 249-byte product name, 4-byte product code, and 1-byte key data locked/unlocked status flag, and a 1-byte hexadecimal checksum.

The key data control program stored to the first user's data storage medium (IC card) that is the source for copying to the second user then generates key data for copying to the second user's data storage medium by changing the 1-byte key data status flag to the value that locks the key data. For example, if this key data status flag is set to 0 to unlock the key data, the flag is set to 1 to generate the key data.

It will be obvious to one with ordinary skill in the related art that various levels of key data locking can be achieved to let the user use a certain amount of information. For example, this key data status flag could be set to 0 to unlock the key data, to 1 to lock the information, to 2 to let the user use 10% of the information, and to 3 to allow 80% of the information to be used. The user unit controller 22 of the digital information controller 13 controls the first user card controller 15 to obtain the locked key data from the first user's storage medium (internal memory of the IC card).

To copy (write) the locked key data to the second user card, user unit controller 22 of the digital information controller controls the second user card controller 16 to copy (write) the key data to the second user card (internal memory of the IC card). It will be obvious that the first user card and second user card can be used in either the first user card controller 15 or second user card controller 16. Generating the key data in which the locked/unlocked status flag is changed can be accomplished with greater security if done inside the IC card. Yet greater security can be achieved if the key data control program encrypts the key data.

It should be noted that a marketer-specific code is always used when writing key data to storage. If writing is accomplished without using this code, the key data can be locked when copying it from the first user to the second user card by writing the key data with a method that always appends the lock information 138 to the key data 137.

Addition of lock data 161 to key data 160 means that the digital information 158 copied from the first user card cannot be reproduced directly by the second user. The second user must first access the digital information seller 150 or support center 151 in order to reproduce the digital information 158.

A method whereby the second user pays a fee and then plays back digital information 157 is described next with reference to the flow chart in FIG. 16.

When the second user storage medium (e.g., IC card) storing the locked key data is loaded into user card controller 1, the user unit controller (PC, for example) of the digital information controller 13 controls capturing the key data by way of user card controller 1. This transmission of key data to the support center is accomplished using a telephone line connection, for example, through user-side external communications means 23 (such as a modem).

The support center determines if the received key data is supported by the support center. If it is, it returns data indicating a fee determined from the key data. The second user then sends the requested amount to the support center. The support center then performs a process for unlocking the locked key data just received from the second user.

In unlocking the key data, computing a key data value using the marketer-specific code for the digital information is an algorithm that can change data indicating a particular lock status. When the unlocking process ends, the key data is sent from the support center to the second user side. The key data transmitted over the communications line is encrypted so that key data stolen from the line over which the key data is transmitted cannot be used. Having remitted the required fee and received the unlocked key data, the second user can then play the digital information back using the new key data.

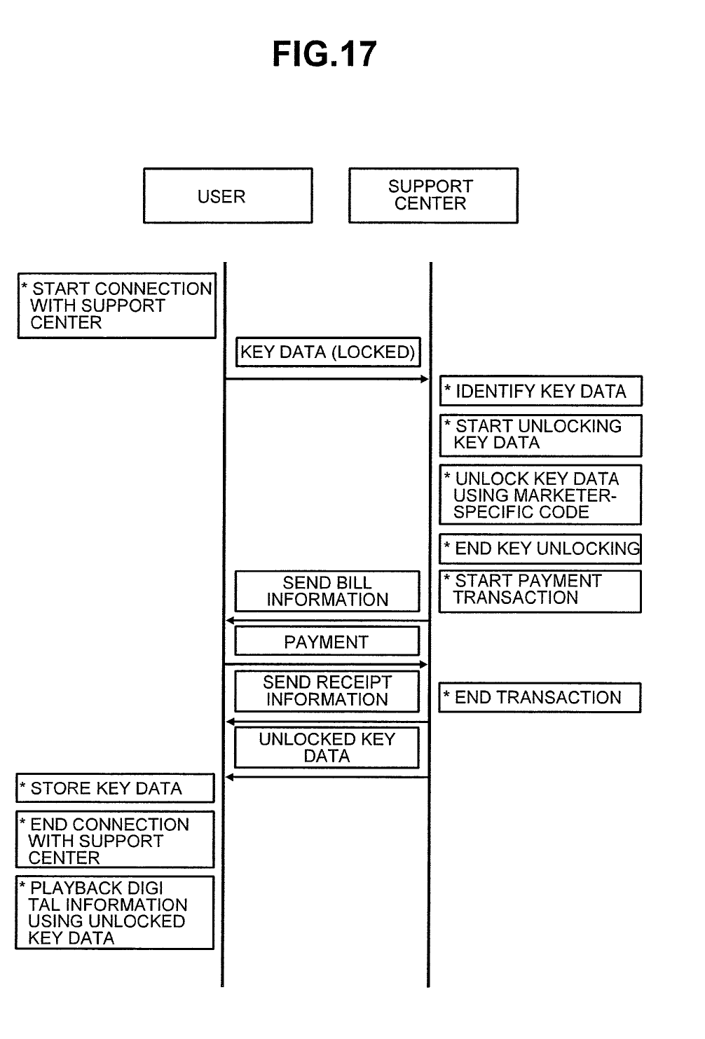

Another method whereby the second user pays a fee in order to use digital information 157 is described next below with reference to the flow chart in FIG. 17.

The flow chart in FIG. 17 differs from that in FIG. 16 in the order of the key data unlocking process performed by the support center, and the fee collection process.

In this case the second user accesses the support center and sends the key data. Upon receiving the key data, the support center identifies the key data and begins unlocking the key data. When the key data is unlocked, a payment request is returned to the user.

When the second user remits payment and payment is recorded, the support center returns the unlocked key data and payment receipt information.

Because the order of the key data unlocking process and fee collection process is different in FIG. 16 and FIG. 17, the processes for handling errors and cancelling unlocking the key data differ. In FIG. 16 unlocking the key data occurs after the fee is received from the user. If the user requests cancelling the key data unlocking process in this case, it is sufficient to not run the unlocking process, and the support center thus avoids an unnecessary operation. In FIG. 17, however, key data unlocking occurs before payment is received, and the unlocked key data can be sent to the user immediately upon receipt of payment. User waiting time is thus reduced. The possibility of not being able to send the key data to the user because of an interrupted connection after payment is received is also reduced.

It should be noted that payment can be effected using cash or electronic money.

Furthermore, because the key data is different for each digital information unit, storing electronic money in the marketer area separately according to the key data when plural digital information units are used makes it possible to distinguish the various sellers for whom transaction fees are collected, and the transfer processes for recovering collected fees can be simplified.

In addition, if there becomes insufficient memory to store a particular unit of key data 137 when storing plural key data units to memory, the user can be so notified and the unnecessary key data deleted.

Furthermore, it is essential to notify the user at the beginning of any copy operation that there is fee for copying the data. While the way in which the user is notified can vary, the user must always be so notified.

Furthermore, while not shown in the figures, transaction fees collected from the user by the support center 131 are preferably sent on-line in real time to the seller 130.

Furthermore, transaction fee data recoverable by the seller is generated whenever a digital information copy is made, even between third and fourth users, and the transaction fees for the digital information can be collected by the seller when the user makes access in order to use the copied data. Increased sales can therefore be expected as a result of user-user copying, and the method of the present invention is therefore an effective way to increase sales through routes (such as word of mouth) other than direct seller-user transactions.

It should be further noted that while digital information 154, 158 and key data 156, 160 are described stored to the same storage medium 153, 157 in this embodiment, they can also be store to different media as in the first embodiment.

Furthermore, by encrypting the key using user-specific private key data as in the first embodiment, encryption information related to the user is used. The digital information sales system is thus secure and safe with respect to user-user copies.

Furthermore, control of copying key data and control of unlocking key data are defined in the key data control program distributed and provided by the marketer, for example. This key data control program is stored to the user's data storage medium in conjunction with copying the key data.

It should be noted that this embodiment, which copies key data in an unusable state, offers greater security than configurations in which copying the key data to a second user card is simply prohibited.

For example, a method that prohibits copying the key data to a second user card and forces the user to access another device to obtain usable key data must use the same key data for all digital information of a particular sale unit (such as one movie or one song). With this method, interpreting the key data enables a number of people to decrypt and use the digital information. Security is thus relatively low. However, if the key data is copied so that it is unusable as in the present embodiment, plural keys can be used for the same sale unit of digital information (such as a movie). Furthermore, the support center can provide support for these plural keys by simply sending the copied key data to the support center. Therefore, when plural keys are allocated to digital information of a particular sale unit (such as one movie or one song), interpreting one of the keys will not enable other units of the same digital information to be used, and security is thus greater.

The method of the present embodiment ensures that the seller can collect fees for using its digital information when the digital information is copied between users because a user that has made a copy must access the seller in order to use the data. This method is thus able to manage copying digital information between users having playback terminals connected to the network, permit the use of digital information in real time when requested by a user, and collect fees for these services.

[Effects of the invention]

The present invention prevents unauthorized copying between users of digital information sold and distributed by a seller, and enables the seller to reliably collect fees for the distributed and copied digital information.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A digital information sales method, comprising:
a step for storing to a first storage medium key data indicating permission to use the digital information; and
a step for storing to the first storage medium a program for controlling a digital information controller to store a fee for using the digital information to a marketer area that cannot be accessed by the storage medium owner when copying key data from the first storage medium to which the key data is written to a second storage medium using the digital information controller.

2. A digital information sales method, comprising:
a step for storing to a first storage medium key data indicating permission to use the digital information; and
a step for storing to the first storage medium a program having a function for storing a fee for using the digital information to a marketer area of the storage medium that cannot be accessed by the storage medium owner when copying key data from the first storage medium to a second storage medium using the digital information controller, and
a function for controlling the digital information controller to send fees stored to m marketer area to the marketer when communicating using the first storage medium.

3. A digital information sales method according to claim 1, wherein:
said program has a function for controlling the digital information controller to store a fee for using the digital information to a marketer area that cannot be accessed by the storage medium owner when copying key data from storage medium N−1 (where N is an integer of 3 or more) to storage medium N.

4. A digital information sales method according to claim 2, wherein:
said program has a function for controlling the digital information controller to store a fee for using the digital information to a marketer area that cannot be accessed by the storage medium owner when copying key data from storage medium N−1 (where N is an integer of 3 or more) to storage medium N.

5. A digital information sales method according to claim 3, wherein:
said program has a function for controlling so as to store said usage fee to said marketer area of storage medium N.

6. A digital information sales method according to claim 4, wherein:
said program has a function for controlling so as to store said usage fee to said marketer area of storage medium N.

7. A digital information sales method according to claim 3, wherein:
said program has a function for controlling so as to compare a user-marketer transaction count from storage medium N and from storage medium N−1, and storing said usage fee to the marketer area of the storage medium having the higher transaction count.

8. A digital information sales method according to claim 4, wherein:
said program has a function for controlling so as to compare a user-marketer transaction count from storage medium N and from storage medium N−1, and storing said usage fee to the marketer area of the storage medium having the higher transaction count.

9. A digital information sales method according to claim 1, wherein:
said program has a function for controlling an ATM terminal to send money information stored in the marketer area of the storage medium to the digital information sales apparatus when a storage medium having a usage/purchase amount stored in the marketer area is inserted to the ATM machine.

10. A digital information sales method according to claim 2, wherein:
said program has a function for controlling an ATM terminal to send money information stored in the marketer area of the storage medium to the digital information sales apparatus when a storage medium having a usage/purchase amount stored in the marketer area is inserted to the ATM machine.

11. A digital information sales method comprising:
a step for storing to a first storage medium key data indicating permission to use the digital information; and
a step for storing to the first storage medium a program having a function for controlling the digital information controller so that key data is copied in an unusable state when copying key data from the first storage medium to which the key data is written to a second storage medium using the digital information controller.

12. A digital information sales method, comprising:
a step for storing to a first storage medium key data indicating permission to use the digital information;
a step storing to the first storage medium a program having a function for controlling the digital information controller so that key data is copied in an unusable state when copying key data from the first storage medium to which the key data is written to a second storage medium using the digital information controller, and
a function for controlling the digital information controller to access the digital information marketer through a communications means when playing back the copied digital information to convert the key data stored to the second storage medium to a usable state; and
a step for sending information for setting key data stored to the second storage medium to a usable state when access is made using the second storage medium containing unusable-state key data and the digital information usage fee is paid.

13. A digital information sales apparatus, comprising:
memory for storing digital information;
key data memory for storing key data indicating permission to use the digital information; and
program memory for storing a program having a function for controlling the digital information controller so that key data is copied in an unusable state when copying key data to a second storage medium using the digital information controller from the first storage medium to which the key data is written as a result of purchasing the digital information and key data;
wherein said key data and said program are stored to the buyer's storage medium when the digital information is sold.

14. A digital information sales apparatus, comprising:
memory for storing digital information;
key data memory for storing key data indicating permission to use the digital information; and
program memory for storing a program having a function for controlling the digital information controller so that key data is copied in an unusable state when copying key data to a second storage medium using the digital information controller from the first storage medium to which the key data is written as a result of purchasing the digital information and key data, and
a function for controlling the digital information controller to access the digital information marketer through a communications means when playing back the copied digital information to convert the key data stored to the second storage medium to a usable state;
wherein the key data and said program are stored to the buyer storage medium when the digital information is sold, and information for setting key data stored to the second storage medium to a usable state is sent when access is made using the second storage medium containing unusable-state key data and the digital information usage fee is paid.

15. A medium for storing a program readable by a control device having a function for controlling a digital information controller, which has a means for controlling a first medium for storing key data indicating permission to use digital information, and a means for copying to a second medium the key data stored to the first medium, wherein said program has:
a function for achieving in the control device a function for setting the key data to an unusable state and storing the unusable-state key data to the second medium when copying key data stored to the first medium to the second medium.

16. A storage medium for storing a program readable by a control device having a function for controlling a digital information controller, which has a means for controlling a first medium for storing key data indicating permission to use digital information, a means for copying to a second medium the key data stored to the first medium, a means for controlling the second medium storing the copied key data, and a communications means for communicating with an external device, wherein said program has a function for achieving in the control device:
a function for setting the key data to an unusable state and storing the unusable-state key data to the second medium when copying key data stored to the first medium to the second medium; and
a function for setting to a usable state the unusable-state key data stored to the second medium when the copied digital information is played back by communicating with the digital information sales apparatus using the second medium by way of the communications means.

17. A digital information sales method according to claim 1, wherein: the first storage medium and second storage medium are each an IC card containing electronic money information and key data unique to the IC card, and key data is encrypted using the unique IC card key data when the key data is copied to the first storage medium or second storage medium.

18. A digital information sales method according to claim 2, wherein: the first storage medium and second storage medium are each an IC card containing electronic money information and key data unique to the IC card, and key data is encrypted using the unique IC card key data when the key data is copied to the first storage medium or second storage medium.
